(19) United States
(12) Patent Application Publication
(10) Pub. No.: US 2010/0089736 A1
(43) Pub. Date: Apr. 15, 2010

(54) KEYSWITCH AND KEYBOARD

(76) Inventors: WEN-YU TSAI, Dacheng Township (TW); Lei-Lung Tsai, Sinjhuang City (TW)

Correspondence Address: PATTERSON & SHERIDAN, LLP - - - IPTEC, 3040 Post Oak Boulevard, Suite 1500, Houston, TX, 77056-6582, US

(21) Appl. No.: 12/575,213

(22) Filed: Oct. 7, 2009

(30) Foreign Application Priority Data
Oct. 9, 2008 (TW) 097218174

(51) Int. Cl. H01H 13/705; H01H 13/70

(52) U.S. Cl. 200/5 A; 200/344

(57) ABSTRACT

The invention discloses a keyswitch and a keyboard. The keyboard includes a substrate, an upper cover and a plurality of the keyswitches. The upper cover, disposed on the substrate, has a plurality of accommodating spaces. Each keyswitch is respectively disposed in one of the accommodating spaces. Each keyswitch includes a keycap and a lift support device. The keycap has a skirt portion. The skirt portion contacts the upper cover. The lift support device is disposed between the keycap and the substrate. The lift support device enables the keycap to move vertically relative to the substrate. A complete surface is formed by the upper cover, the keycaps and the skirt portions, so as to prevent light leakage and maintain an equal height of the keyswitches.

### BACKGROUND OF THE INVENTION

1. Field of the Invention

The invention relates to a keyswitch and a keyboard and, more particularly, to a keyswitch having a skirt portion.

2. Description of the Prior Art

In developed countries, almost every family has their own computers. People may acquire information, exchange message or communicate with others over internet via their computers. The most common input device for the computer is the keyboard, and the keyswitch is one of the basic components of the keyboard.

With the ever-developing technology, the consumer-electronics become more personalized and humanized. Various types of keyboards are developed according to different applications. For example, there are the mechanical keyboard, which is designed for a traditional desktop computer, and the membrane keyboard, which is developed for the portable computer in the first place. Recently, an illuminated keyboard is introduced to users. The illuminated keyboard can be easy to use even in some dark situation. The light beams in the illuminated keyboard are guided through predetermined pattern to light up the transparent regions (e.g. character-shaped regions on keycaps of the keyboard). The keyboard may have an upper cover for preventing the light leakage.

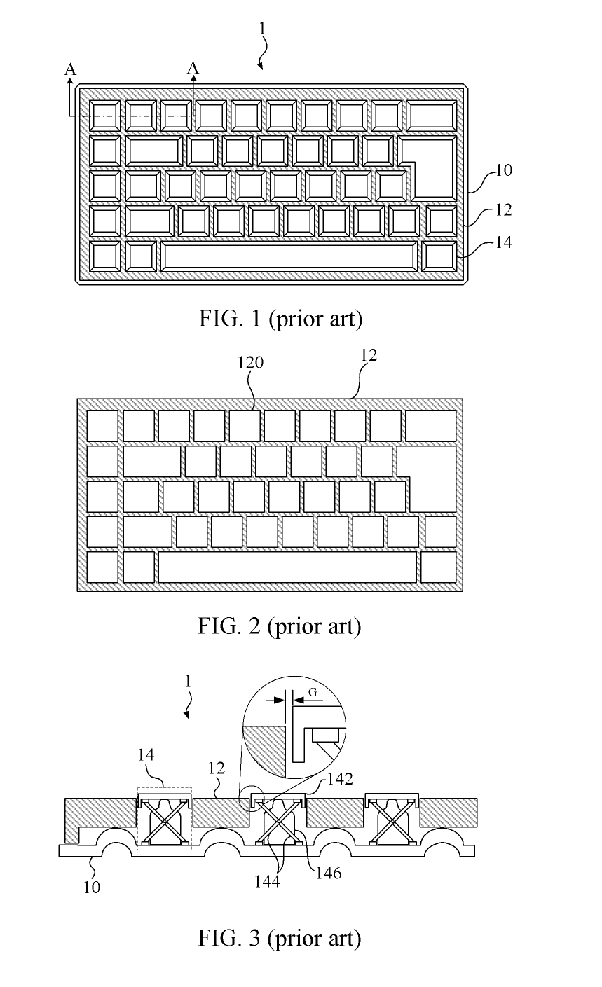

Please FIG. 1 and FIG. 2. FIG. 1 is a schematic diagram illustrating a keyboard 1 in prior art. FIG. 2 is a schematic diagram illustrating an upper cover 12 in FIG. 1. As shown in FIG. 1, the keyboard 1 includes a substrate 10, an upper cover 12 and keyswitches 14. The upper cover 12 is disposed over the substrate 10. The upper cover 12 has a plurality of accommodating spaces 120. Each keyswitch 14 is disposed within one of the accommodating spaces 120.

Please refer to FIG. 3. FIG. 3 is a sectional view diagram illustrating the keyboard 1 in FIG. 1 along A-A direction. As shown in FIG. 3, each keyswitch 14 includes a keycap 142, a lift support device 144 and a flexible component 146. The lift support component 144 and the flexible component 146 are disposed between the keycap 142 and the substrate 10.

The lift support device 144 is used for carrying the keycap 142 to move vertically relative to the substrate 10. The flexible component 146 is served as the medium for storing and releasing the elastic force while the keycap 142 moving vertically.

Each keyswitch 14 is respectively located in one accommodating space 120 of the upper cover 12, and the keyswitch 14 can move vertically depending on the pushing action of users. The keyswitch 14 does not contact the upper cover 12. However, there is a gap G (shown in FIG. 3) between the upper cover 12 and the keycap 142 of the keyswitch 14. In an illuminated keyboard, the gap G may cause the light leakage. The users may be interfered by the leaked light, such that they may find it harder to identify the print (character or mark) on the keyswitches 14. Besides, key-height of the keyswitches 14 in prior art are based on their lift support devices 144 and flexible components 146 individually. However, there are dozens of keyswitches 14 on one keyboard 1, so that it is almost impossible to maintain key-height of the keyswitches 14 equal.

The invention discloses a keyswitch and a keyboard, to solve aforesaid problems.

### SUMMARY OF THE INVENTION

A scope of the invention is to provide a keyswitch, which has a skirt portion used for shielding light or spacing the keyswitch.

Another scope of the invention is to provide a keyboard comprising aforesaid keyswitch.

According to an embodiment, the keyboard includes a substrate, an upper cover and a plurality of keyswitches. The upper cover is disposed over the substrate. The upper cover has a plurality of accommodating spaces. Each keyswitch is disposed within one of the accommodating spaces. Each keyswitch includes a keycap and a lift support device. The keycap has a skirt portion. The skirt portion may contact the upper cover. The lift support device is disposed between the keycap and the substrate. The lift support device is used for carrying the keycap to move vertically relative to the substrate.

In other words, the keyboard in the invention has the keycaps with the skirt portions. A complete surface is formed by the upper cover, the keycaps and the skirt portions, so as to prevent light leakage and improve the illumination efficiency of the backlight of the keyboard. In this case, the keycap may move vertically relative to the substrate according to user's manipulation. When user pushes and then releases the keyswitch, the keycap bounces up until the keycap is stopped by the upper cover, so as to maintain an equal key-height of the keyswitches. Besides, the skirt portions may further include soft components. The keycaps utilize the soft components on their skirt portions to contact the upper cover, such that the collision noise can be eliminated. Accordingly, the keyboard in the invention can be implemented with no light leakage, no collision noise and equal key-height.

The advantage and spirit of the invention may be understood by the following recitations together with the appended drawings.

BRIEF DESCRIPTION OF THE APPENDED DRAWINGS

FIG. 1 is a schematic diagram illustrating a keyboard in prior art.

FIG. 2 is a schematic diagram illustrating an upper cover in FIG. 1.

FIG. 3 is a sectional view diagram illustrating the keyboard in FIG. 1 along A-A direction.

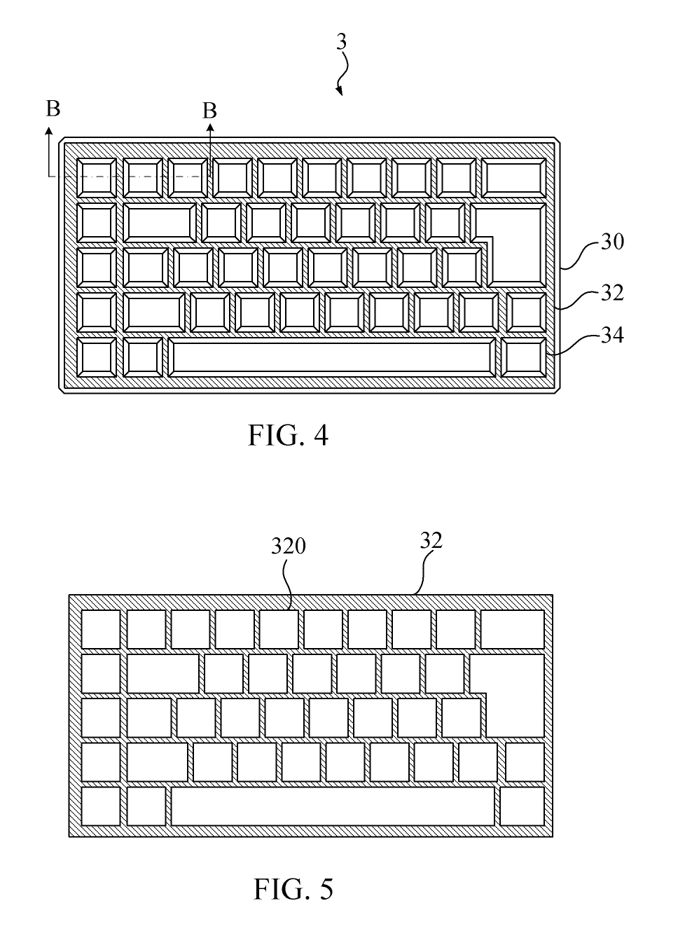

FIG. 4 is a schematic diagram illustrating a keyboard according to a first embodiment of the invention.

FIG. 5 is a schematic diagram illustrating an upper cover in FIG. 4.

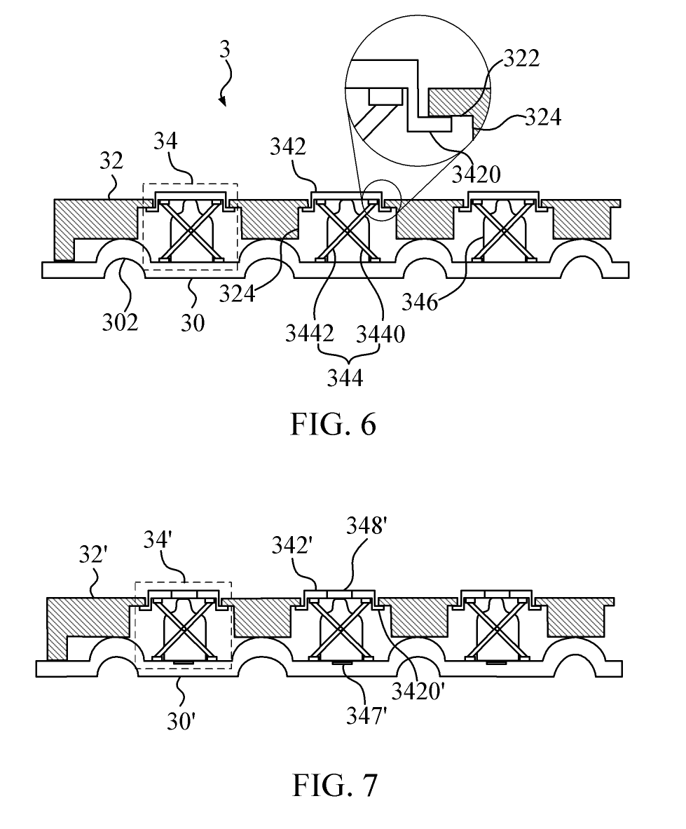

FIG. 6 is a sectional view diagram illustrating the keyboard in FIG. 4 along B-B direction.

FIG. 7 is a sectional view illustrating keyswitches according to another embodiment of the invention.

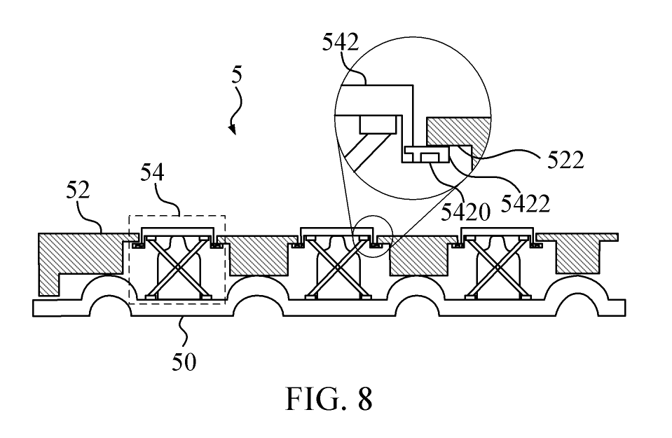

FIG. 8 is a sectional view diagram illustrating a keyboard according to a second embodiment of the invention.

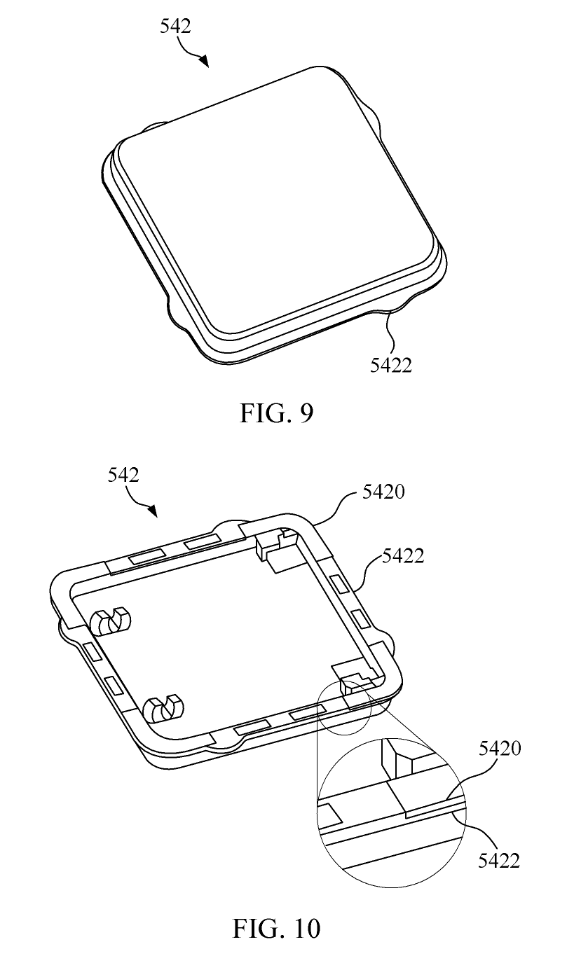

FIG. 9 is an outside perspective view illustrating the keycap in FIG. 8.

FIG. 10 is an outside perspective view illustrating the keycap in FIG. 9 in another view angle.

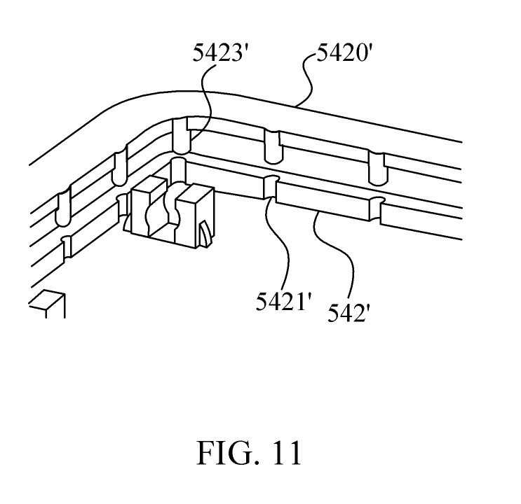

FIG. 11 is a partial exploded view illustrating a keycap according to a third embodiment of the invention.

### DETAILED DESCRIPTION OF THE INVENTION

Please refer to FIG. 4, FIG. 5 and FIG. 6. FIG. 4 is a schematic diagram illustrating a keyboard 3 according to a first embodiment of the invention. FIG. 5 is a schematic diagram illustrating the upper cover 32 in FIG. 4. FIG. 6 is a sectional view diagram illustrating the keyboard 3 in FIG. 4 along B-B direction.

In the embodiment, the keyboard 3 includes a substrate 30, an upper cover 32 and a plurality of keyswitches 34. The upper cover 32 is disposed over the substrate 30. The upper cover 32 has a plurality of accommodating spaces 320, which are arranged to form a grid structure. There are stopping surfaces 322 and slide-ways 324 on the sides of each accommodating space 320. Each keyswitch 34 is respectively disposed within one of the accommodating spaces 320. The keyswitches 34 are disposed on the substrate 30, and can be pressed or manipulated by users in typing or activating some other functions.

As shown in FIG. 6, each keyswitch 34 in the embodiment includes a keycap 342, a lift support device 344 and a flexible component 346. The keycap 342 has a skirt portion 3420. In this embodiment the keycap 342 and the skirt portion 3420 are formed in one piece. The lift support device 344 and the flexible component 346 are disposed between the key cap 342 and the substrate 30. Every keyswitches 34 are respectively disposed on different spots over the substrate 30. In other word, one singular keyswitch 34 may correspond to one part of the substrate 30. In this embodiment, the substrate 30 further has protruded portions 302. The protruded portions 302 serves as locking stands while assembling upper cover 32 to the substrate 30. In practical applications, tapped holes can be disposed upon the protruded portions 302.

The lift support device 344 includes a first support component 3440 and a second support component 3442. The first support component 3440 and the second support component 3442 are pivotally connected in a scissors shape. The first support component 3440 and the second support component 3442 may rotate relatively, to bring the keycap 343 up and down relative to the substrate 30.

In the embodiment, the upper cover 32 can be used for spacing all of the keycaps 342 of the keyswitch 34. The skirt portions 3420 of the keycaps 342 are disposed within the slide-ways 324. Following movement of the keycap 342, the skirt portion 3420 may slide vertically along the slide-way 324. Besides, the flexible component 346 is used to cooperate with the lift support device 344 for storing the elastic force. In practical applications, when users press one keyswitch 34, the keycap 342 descends with its corresponding lift support device 344. In the meantime, the skirt portion 3420 of the keycap 342 slides downward along the slide-way 324 of the upper cover 32 to the substrate 30. In this period of time, the flexible component 346 is squeezed to deform and accumulate the elastic force. When users release the keyswitch 34, the flexible component 346 releases the elastic force to push the keycap 342 upward. In the meantime, the skirt portion 3420 of the keycap 342 slides upward along the slide-way 324 until the skirt portion 3420 is stopped by the stopping surface 322 of the upper cover 32.

In other words, when one of the keyswitches 34 is pressed, the skirt portion 3420 of the keycap 342 slides in the corresponding slide-way 324 of the upper cover 32, so the keyswitch 34 may move stably in this way. Besides, the skirt portion 3420 of the keycap 342 is stopped by the stopping surface 322, such that the upper cover 32 in the invention can be used to maintain the same key-height between all keyswitches 34, but the invention is not limited to this.

Please refer to FIG. 7. FIG. 7 is a sectional view illustrating keyswitches 34′ according to another embodiment of the invention. The main difference from the first embodiment is that, the keyswitches 34′ further includes a light-emitting component 347′ disposed on the substrate 30′ and a transparent region 348′ disposed on the keycap 342′. The light-emitting component 347′ may emit light across the opaque keycap 342′ via the transparent region 348′. The transparent region 348′ can be an optical channel with specific pattern, or it can be made of transparent material. The specific pattern of the transparent region 348′ may represent a character or a function corresponding to each different keyswitch 34′, such that users may easily identify the function of each keyswitch 34′ even without sufficient lightness. In this embodiment, the upper cover 32′ contacts the skirt portion 3420′ and it may prevent the light from leaking or scattering via the gaps between keyswitches 34, so as to improve the illumination efficiency. Other structures of the keyswitches 34′ are similar to the first embodiment, and not repeated here.

According to the aforesaid embodiments, the keyboard of the invention utilizes the upper cover, the keycap and the skirt portion to form a complete surface, so as to ensure that the light generated by the light-emitting component only projects through the transparent region. Besides, the grid-shaped upper cover can maintain equal key-height for all keyswitches. Accordingly, the keyboard of the invention can has high illumination efficiency and identical key-height.

In the first embodiment, when keyswitch 34 bounces up and the skirt portion 3420 contacts the stopping surface 322 of the upper cover 32, a certain degree of vibration or noise may be generated by the collision between the skirt portion 3420 and the stopping surface 322.

Please refer to FIG. 8. FIG. 8 is a sectional view diagram illustrating a keyboard 5 according to a second embodiment of the invention. The keyboard 5 has a substrate 50, an upper cover 52 and a plurality of keyswitches 54. A keycap 542 of each keyswitch 54 has a skirt portion 5420, which is formed in one piece with the keycap 542.

The main different from the first embodiment is that, the keycap 542 in the second embodiment has a soft component 5422 disposed on the surface of the skirt portion 5420. Please also refer to FIG. 9 and FIG. 10 at the same time. FIG. 9 is an outside perspective view illustrating the keycap 542 in FIG. 8. FIG. 10 is an outside perspective view illustrating the keycap 542 in FIG. 9 in another view angle. The soft component 5422, disposed on the surface of the skirt portion 5420, is formed by covering the skirt portion 5420 with soft material in an injection molding process. Precisely, the soft component 5422 is formed by second-time injection molding process. In practical applications, the keycap 542 and the skirt portion 5420 formed in one piece are usually made of plastic material. The keycap 542 and the skirt portion 5420 are formed in the first-time injection molding process. Then, the soft material is injected to cover upon the surface of the skirt portion 5420, so as to form the soft component 5422 in the second-time injection molding process.

In this case, the keycap 542 contacts the stopping surface 522 of the upper cover 52 with its soft component 5422 on the skirt portion 5420. In practical applications, the soft component 5422 can be made of rubber or some deformable soft material. The characteristic of the soft material is utilized to buffer the collision between the skirt portion 5420 and the upper cover 52 for reducing the collision noise, so as to elevate the comfort while manipulating the keyboard 5. Other structures of the keyboard 5 are similar to the first embodiment, and not repeated here.

In another embodiment, the soft component 5422 is formed by coating the skirt portion with soft material in a surface spraying process. In the embodiment, the soft component 5422 can be made of rubber or some deformable soft material. In the embodiment, the soft material is sprayed to coat on the surface of the skirt portion 5420 opposite to the upper cover 52. The characteristic of the soft material is utilized to buffer the collision between the skirt portion 5420 and the upper cover 52 for reducing the collision noise.

In each keyswitch 54 of the keyboard 5, the skirt portion 5420 and the keycap 542 are formed in one piece, and the height of them is limited by the upper cover 52. Besides, there are soft components, formed by injection molding or spraying process, on the surface of the skirt portion 5420, so as to form a keyboard 5 with identical key-height and low noise.

Please refer to FIG. 11. FIG. 11 is a partial exploded view illustrating a keycap 542′ according to a third embodiment of the invention. The main difference from the second embodiment, the keycap 542′ and the skirt portion 5420′ in this embodiment are not formed in one piece as shown in FIG. 11. In this embodiment, the keycap 542′ has a first engaging portion 5421′, and the skirt portion 5420′ has a second engaging portion 5423′. The skirt portion 5420′ utilizes its second engaging portion 5423′ to be engaged on the first engaging portion 5421′ of the keycap 542′. The skirt portion 5420′ includes a soft component, or at least part of the skirt portion 5420′ can be formed by a soft component. In this case, the complete skirt portion 5420′ is formed by a soft component. In other words, the soft component made of soft material is served as the skirt portion 5420′ in this embodiment.

As shown in FIG. 11, the first engaging portion 5421′ can be a round recess caved inward from the keycap 542′, but not limited to this. The second engaging portion 5423′ can be a cylinder, corresponding to the first engaging portion 5421′, extended from the skirt portion 5420′.

In the third embodiment, it utilizes the soft component to serve as the skirt portion 5420′. In other words, the skirt portion 5420′ has the characteristic of the soft component. The soft skirt portion 5420′ is fixed on the keycap 542′ by assembling, so as to solve the noise problem. In addition, the keycap 542′ with the skirt portion 5420′ can be used in an illuminated keyboard to elevate the illumination efficiency.

In summary, the keyboard in the invention has the keycaps with the skirt portions. A complete surface is formed by the upper cover, the keycaps and the skirt portions, so as to prevent light leakage and improve the illumination efficiency of the backlight of the keyboard. In this case, the keycap may move vertically relative to the substrate according to user's manipulation. When user pushes and then releases the keyswitch, the keycap bounces up until the keycap is stopped by the upper cover, so as to maintain an equal key-height of the keyswitches. Besides, the skirt portions may further include soft components. The keycaps utilize the soft components on their skirt portions to contact the upper cover, such that the collision noise can be eliminated. Accordingly, the keyboard in the invention can be implemented with no light leakage, no collision noise and equal key-height.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A keyswitch, comprising:
a substrate;
a keycap, the keycap having a skirt portion; and
a lift support device disposed between the keycap and the substrate, the lift support device being used for carrying the keycap to move vertically relative to the substrate.

2. The keyswitch of claim 1, wherein the keycap has a first engaging portion, the skirt portion has a second engaging portion, the second engaging portion of the skirt portion is engaged to the first engaging portion of the keycap, and the skirt portion comprising a soft component.

3. The keyswitch of claim 1, wherein the keycap and the skirt portion are formed in one piece.

4. The keyswitch of claim 1, wherein the skirt portion comprises a soft component and the soft component is formed by covering the skirt portion with soft material in an injection molding process.

5. The keyswitch of claim 1, wherein the skirt portion comprises a soft component and the soft component is formed by coating the skirt portion with soft material in a surface spraying process.

6. The keyswitch of claim 1, wherein the lift support device comprises a first support component and a second support component, and the first support component and the second support component are pivotally connected in a scissors shape.

7. The keyswitch of claim 1, further comprising a flexible component disposed between the keycap and the substrate.

8. The keyswitch of claim 7, wherein the flexible component is a rubber.

9. A keyboard, comprising:
a substrate;
an upper cover disposed over the substrate, the upper cover having a plurality of accommodating spaces;
a plurality of keyswitches, each keyswitch being disposed within one of the accommodating spaces, each keyswitch comprising:
a keycap, the keycap having a skirt portion, the skirt portion being used for contacting the upper cover; and
a lift support device disposed between the keycap and the substrate, the lift support device being used for carrying the keycap to move vertically relative to the substrate.

10. The keyboard of claim 9, wherein the keycap has a first engaging portion, the skirt portion has a second engaging portion, the second engaging portion of the skirt portion is engaged to the first engaging portion of the keycap, and the skirt portion comprising a soft component.

11. The keyboard of claim 9, wherein the keycap and the skirt portion are formed in one piece.

12. The keyboard of claim 9, wherein the skirt portion comprises a soft component and the soft component is formed by covering the skirt portion with soft material in an injection molding process.

13. The keyboard of claim 9, wherein the skirt portion comprises a soft component and the soft component is formed by coating the skirt portion with soft material in a surface spraying process.

14. The keyboard of claim 9, wherein the lift support device comprises a first support component and a second support component, and the first support component and the second support component are pivotally connected in a scissors shape.

15. The keyboard of claim 9, wherein each keyswitch further comprises a flexible component disposed between the keycap and the substrate.

16. The keyboard of claim 15, wherein the flexible component is a rubber.
